(19) United States
(12) Patent Application Publication
(10) Pub. No.: US 2012/0163866 A1
(43) Pub. Date: Jun. 28, 2012

(54) Image Forming Apparatus

(75) Inventor: Hiroki MORISHITA, Osaka (JP)

(73) Assignee: Kyocera Mita Corporation, Osaka (JP)

(21) Appl. No.: 13/334,364

(22) Filed: Dec. 22, 2011

(30) Foreign Application Priority Data
Dec. 24, 2010 (JP) 2010-287169

(51) Int. Cl. G03G 15/00; G03G 21/00

(52) U.S. Cl. 399/167; 399/357

(57) ABSTRACT

An image forming apparatus according to an aspect of the present disclosure includes an image carrier, a cleaning member and a drive mechanism. The image carrier carries a toner image. The cleaning member removes residual toner on the image carrier by contacting a surface of the image carrier. The drive mechanism rotates the image carrier and for reciprocating the image carrier in an axial direction of the image carrier.

This application is based upon and claims the benefit of priority from the corresponding Japanese Patent Application No. 2010-287169 filed on Dec. 24, 2010, the entire contents of which are incorporated herein by reference.

### BACKGROUND

The present disclosure relates to an image forming apparatus such as a copier, a printer, a facsimile, and a multifunction peripheral having functions of those devices, and more particularly, to an image forming apparatus capable of removing residual toner on an image carrier.

Conventionally, in image forming apparatuses, a toner image, which has been formed on an image carrier, is transferred onto a transfer medium such as a sheet, and then residual toner on the image carrier is removed. In order to remove the residual toner on the image carrier, a cleaning blade to be held in press-contact with the image carrier has been widely used. Further, in some cases, foreign matter such as residual toner and paper powder is stuck between the cleaning blade and the surface of the image carrier, and the foreign matter damages the surface of the image carrier. As a countermeasure, in order to remove the foreign matter without damaging the surface of the image carrier, the cleaning blade is reciprocated in an axial direction of the image carrier.

As a technology for reciprocating the cleaning blade in the axial direction of the image carrier, the following technology is well-known. Specifically, a drive shaft for actuating the cleaning blade and a drive gear for driving the drive shaft are provided. When the image carrier rotates, the drive gear is rotated by a gear for the image carrier, and then the rotation of the drive gear is transmitted to the drive shaft. As a result, the cleaning blade is reciprocated by the drive shaft into the axial direction of the image carrier through intermediation of a cam and the like. Residual toner removed by the cleaning blade is housed into a cleaning portion.

However, in the above-mentioned technology, the cleaning blade is reciprocated in the axial direction, and hence a complicated drive mechanism is required. Further, normally, a sealing member is attached to the cleaning portion for the purpose of preventing leakage of the residual toner thus housed, the sealing member sealing a periphery of a foreign-matter carry-in opening of the cleaning portion. In the above-mentioned technology, the cleaning blade to be reciprocated is provided in a vicinity of the foreign-matter carry-in opening of the cleaning portion. Thus, there is risk that a gap is formed between an end portion of the cleaning blade in a moving direction and the sealing member owing to repetitive reciprocation of the cleaning blade, and the removed residual toner scatters from the gap to an outside of the cleaning portion.

It is an object of the present disclosure to provide an image forming apparatus capable of, with a simple structure, removing foreign matter such as residual toner on an image carrier without damaging the surface of the image carrier and preventing scattering of the residual toner thus removed.

### SUMMARY

An image forming apparatus according to an aspect of the present disclosure includes an image carrier, a cleaning member and a drive mechanism. The image carrier carries a toner image. The cleaning member removes residual toner on the image carrier by contacting a surface of the image carrier. The drive mechanism rotates the image carrier and for reciprocating the image carrier in an axial direction of the image carrier.

Further features and advantages of the present disclosure will become apparent from the description of embodiments given below.

### BRIEF DESCRIPTION OF THE DRAWINGS

FIG. 1 is a sectional view of an image forming apparatus according to an embodiment of the present disclosure.

FIG. 2A is a schematic diagram of a drive mechanism in a case where a photosensitive member according to the embodiment of the present disclosure is moved to one side.

FIG. 2B is a schematic diagram of the drive mechanism in a case where the photosensitive member according to the embodiment of the present disclosure is moved to another side.

FIG. 3 is a perspective view of a first gear member and a second gear member of the drive mechanism according to the embodiment of the present disclosure.

FIG. 4 is a sectional view of an image forming section according to the embodiment of the present disclosure.

FIG. 5 is a graph illustrating axial moving amounts of the photosensitive member according to the embodiment of the present disclosure.

FIG. 6 is a graph illustrating axial moving amounts during a process of from exposure to transfer of the photosensitive member according to the embodiment of the present disclosure.

### DETAILED DESCRIPTION

In the following, description is made of an embodiment of the present disclosure with reference to the drawings. Note that, the present disclosure is not limited to this embodiment. Specifically, uses of the present disclosure, terms herein, and the like are not limited to those in this embodiment.

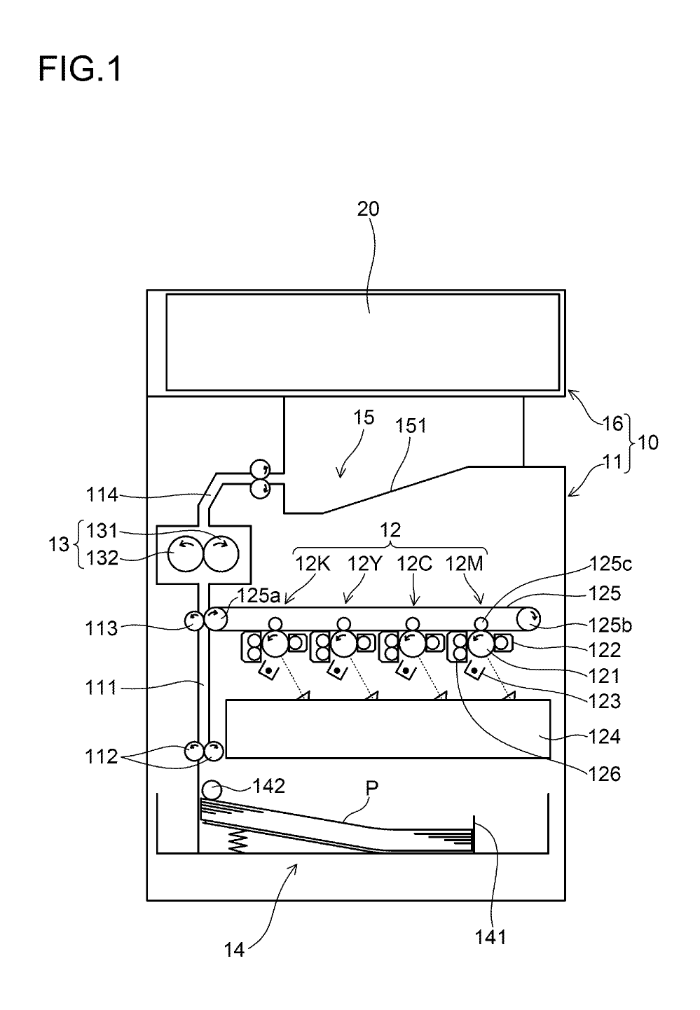

FIG. 1 is a sectional view of an image forming apparatus according to the embodiment of the present disclosure. An image forming apparatus 10 is a tandem color copier of an in-body ejection, and includes a lower apparatus main body 11 and an upper apparatus main body 16.

In the lower apparatus main body 11, there are disposed a sheet feeding portion 14, an image forming section 12, and a fixing portion 13. In the upper apparatus main body 16, there is disposed an image reading portion 20 for reading original images. A ejection space 15 is formed between the lower apparatus main body 11 and the upper apparatus main body 16, and sheets P that have undergone fixing treatment are ejected into the ejection space 15.

The image forming section 12 is provided to form toner images onto the sheets P fed from the sheet feeding portion 14, and a magenta unit 12M, a cyan unit 12C, a yellow unit 12Y, and a black unit 12K are disposed therein from an upstream side toward a downstream side of a rotational direction of an intermediate transfer belt 125 as an intermediate transfer member.

In each of the image forming units 12M, 12C, 12Y, and 12K, there is disposed a photosensitive member 121 as an image carrier. A developing portion 122, an exposure portion 124, a charging portion 123, and a cleaning portion 126 are disposed around the photosensitive member 121.

The developing portion 122 is arranged on the right of the photosensitive member 121 so as to face the same, and supplies toner to the photosensitive member 121. The charging portion 123 is arranged on an upstream side in a rotational direction of the photosensitive member 121 with respect to the developing portion 122 so as to face a surface of the photosensitive member 121, and uniformly charges the surface of the photosensitive member 121.

The exposure portion 124 is provided below the photosensitive member 121 so as to perform scanning exposure on the photosensitive member 121 based on image data such as those of letters and pictures that have been read in the image reading portion 20. The exposure portion 124 is provided with a laser light source, a polygon mirror, and the like (none of which is shown). A laser beam emitted from the laser light source is applied to the surface of the photosensitive member 121 through intermediation of the polygon mirror from the downstream side in the rotational direction of the photosensitive member 121 with respect to the charging portion 123. By the laser beam thus applied, an electrostatic latent image is formed on the surface of the photosensitive member 121, and the electrostatic latent image is developed by the developing portion 122 into a toner image.

The endless intermediate transfer belt 125 is stretched around a drive roller 125a and a tension roller 125b. The drive roller 125a is driven to rotate by a motor (not shown), and the intermediate transfer belt 125 is circulated by being driven based on rotation of the drive roller 125a.

The photosensitive members 121 are arrayed adjacently to each other along a conveying direction below the intermediate transfer belt 125 as a transfer medium so as to be held in contact with the intermediate transfer belt 125. Primary transfer rollers 125c respectively face the photosensitive members 121 while sandwiching the intermediate transfer belt 125, and constitute primary transfer sections by being held in press-contact with the intermediate transfer belt 125. In the primary transfer sections, respective toner images on the photosensitive members 121 are sequentially and primarily transferred onto the intermediate transfer belt 125 at predetermined timings with respect to rotation of the intermediate transfer belt 125. In this way, a toner image obtained by superimposition of four-color toner images: magenta; cyan; yellow; and black is formed on a surface of the intermediate transfer belt 125. After the primary transfer, the cleaning portion 126 houses residual toner removed from the surface of the photosensitive member 121.

A secondary transfer roller 113 faces the drive roller 125a while sandwiching the intermediate transfer belt 125, and constitutes a secondary transfer section by being held in press-contact with the intermediate transfer belt 125. In this secondary transfer section, the toner image on the surface of the intermediate transfer belt 125 is transferred onto the sheet P. After the toner image is transferred onto the sheet P, a belt cleaning device (not shown) removes residual toner on the intermediate transfer belt 125.

The sheet feeding portion 14 is disposed on a lower side in the image forming apparatus 10, and the sheet feeding portion 14 is provided with a sheet tray 141 which is attached to the apparatus main body 11 in a detachable and insertable manner so as to receive the sheets P. On the left of the sheet feeding portion 14, there is disposed a first sheet-conveyance path 111 for conveying, with a conveying roller pair 112, the sheets P sent out from the sheet tray 141 by a pick-up roller 142 toward the secondary transfer section of the intermediate transfer belt 125. Further, on an upper left side of the apparatus main body 11, the fixing portion 13 for performing fixing treatment with respect to the sheets P that have undergone image formation, and a second sheet-conveyance path 114 for conveying the sheets that have undergone fixing treatment onto a sheet ejection tray 151 are disposed.

At an appropriate timing between an image forming operation on the intermediate transfer belt 125 and a sheet feeding operation, the sheet P is conveyed to the secondary transfer section. The sheet P that has been conveyed to the secondary transfer section is subjected to secondary transfer of the toner image that has been formed on the intermediate transfer belt 125 by the secondary transfer roller 113 applied with a bias potential, and then conveyed to the fixing portion 13.

The fixing portion 13 includes a fixing roller 131 to be heated by a heat source and a pressure roller 132 disposed in press-contact with the fixing roller 131, and performs fixing treatment by heating and pressurizing the sheet P that has undergone toner-image transfer. The sheet P that has undergone toner-image fixation passes through the second sheet-conveyance path 114 to be ejected onto the sheet ejection tray 151 by a ejection roller pair.

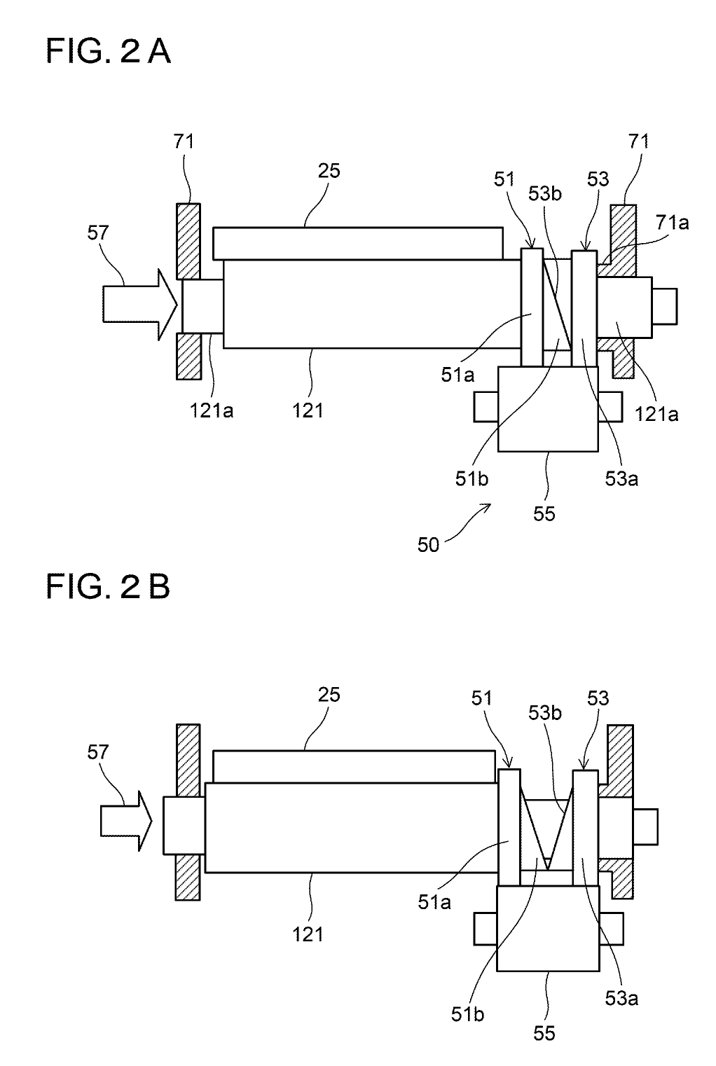

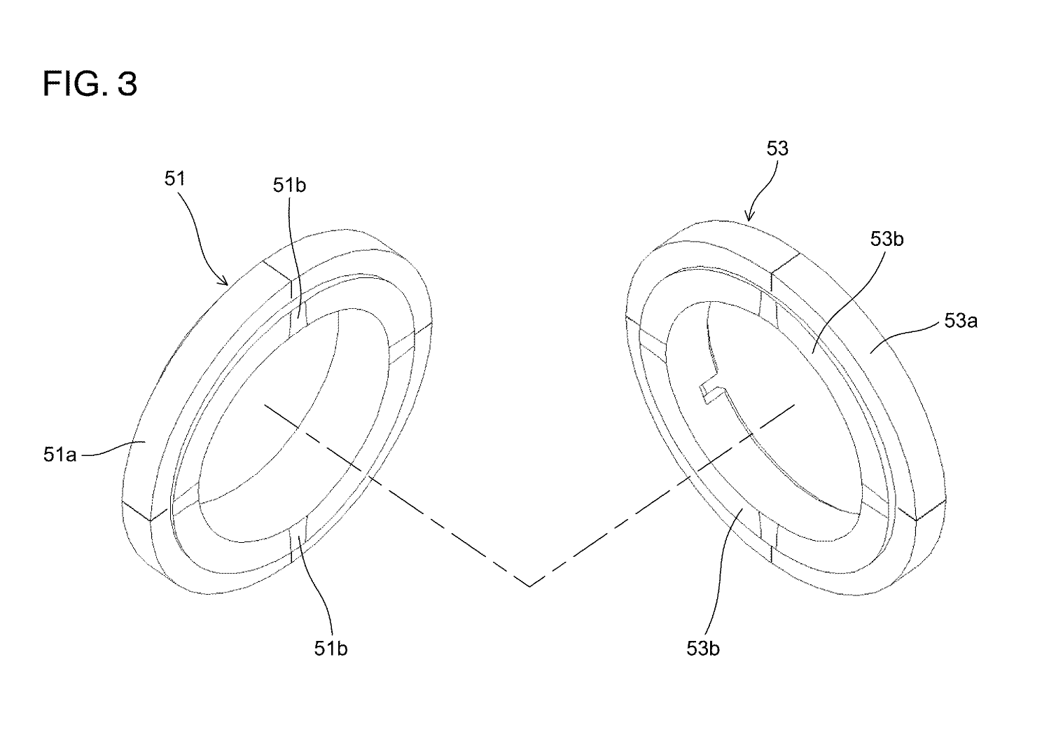

Next, with reference to FIGS. 2A, 2B, and 3, description is made of a drive mechanism 50 for the photosensitive member 121. FIGS. 2A and 2B are each a schematic diagram of the drive mechanism 50. Specifically, FIG. 2A illustrates a case where the photosensitive member 121 is moved to one side by the drive mechanism 50, and FIG. 2B illustrates a case where the photosensitive member 121 is moved to another side by the drive mechanism 50. The photosensitive member 121 reciprocates in a range of FIGS. 2A and 2B. FIG. 3 is a perspective view in which a first gear member 51 and a second gear member 53 of the drive mechanism 50 are separated from each other.

As illustrated in FIG. 2A, in order to clean the photosensitive member 121, a cleaning member (As an example, cleaning blade 25) and the drive mechanism 50 are disposed around the photosensitive member 121. As an example of the cleaning member, a cleaning blade 25 is taken up in the following description. This, however, is not meant to limit the cleaning member to a cleaning blade 25; a cleaning roller or any other member may be used instead.

The cleaning blade 25 is fixed to the cleaning portion 126 (refer to FIG. 1) in a manner of contacting the surface of the photosensitive member 121 so as to remove residual toner on the surface of the photosensitive member 121. The residual toner thus removed is housed in the cleaning portion 126.

Rotary shafts 121a are disposed on both end sides of the photosensitive member 121 in an axial direction, and the first gear member 51 is disposed to axial right-side one of the rotary shafts 121a. The rotary shafts 121a are fitted respectively to support members 71 (apparatus main body) provided on both the sides so as to be movable in the axial direction and rotatable.

The drive mechanism 50 includes the first gear member 51 and the second gear member 53 which are described above, an idle gear 55, and an urging member 57, and rotates and axially reciprocates the photosensitive member 121. With this, structures for rotation and axial movement are simplified, and space saving is achieved. Further, it is possible to employ a structure in which the cleaning blade 25 is fixed to the cleaning portion 126, and hence foreign matter such as residual toner does not scatter to an outside of the cleaning portion 126.

The first gear member 51 includes a first gear 51a and a cam follower 51b. The first gear 51a is a spur gear formed along an outer peripheral surface of the first gear member 51. The cam follower 51b is a protrusion projecting from a right-side surface of the first gear member 51, and abuts a cam surface 53b described below.

The second gear member 53 includes a second gear 53a and the cam surface 53b. Further, the second gear member 53 has a right-side surface to abut a flange portion 71a of the support member 71, and is rotatably fitted to the rotary shaft 121a provided to the photosensitive member 121.

The second gear 53a is a spur gear formed along an outer peripheral surface of the second gear member 53 and being smaller in number of teeth by one than the first gear 51a of the first gear member 51. Further, the second gear 53a is formed in a shifted manner so as to have a pitch circle diameter in conformity with a pitch circle diameter of the first gear 51a. By forming the second gear 53a with a profile-shifted gear, the idle gear 55 described below reliably meshes with the first gear 51a and the second gear 53a. Note that, instead of reducing the number of teeth of the second gear 53a, it is possible to form the first gear 51a with a profile-shifted spur gear smaller in number of teeth by one than the second gear 53a. Alternatively, any one of the first gear 51a and the second gear 53a may be set to be smaller in number of teeth by two or more than another of the first gear 51a and the second gear 53a.

The cam surface 53b is formed on a left-side surface of the second gear member 53 so as to face the cam follower 51b of the first gear member 51 while being different (varying) in axial distance in a circumferential direction.

Specifically, as illustrated in FIG. 3, two cam surfaces 53b are formed separately at 180° in the circumferential direction on the left-side surface of the second gear member 53. Each of the cam surfaces 53b is formed to change (vary) constantly in axial distance by a predetermined amount with respect to a unit rotation angle in the circumferential direction of the cam surfaces 53b. In the first gear member 51, two cam followers 51b are formed separately at 180° in a circumferential direction. With this, when one of the cam followers 51b of the first gear member 51 abuts a predetermined position on one of the cam surfaces 53b of the second gear member 53, another of the cam followers 51b of the first gear member 51 abuts a predetermined position on another of the cam surfaces 53b of the second gear member 53. Therefore, the cam followers 51b abut the cam surfaces 53b at respective corresponding positions. Then, when the first gear member 51 rotates, corresponding to a change in position of the abutting positions of the cam followers 51b and the cam surfaces 53b, the cam followers 51b move in the axial direction, and the photosensitive member 121 moves integrally with the cam followers 51b into the axial direction. When the two cam surfaces 53b and the two cam followers 51b are provided in this way, the cam followers 51b stably abut the cam surfaces 53b, with the result that the photosensitive member 121 smoothly moves in the axial direction. Note that, there may be provided three or more cam surfaces 53b and three or more cam followers 51b. Alternatively, the first gear member 51 may be provided with a cam surface, and the second gear member 53 may be provided with a cam follower.

Referring back to FIG. 2A, the idle gear 55 is formed of a spur gear, which is rotatably supported by the apparatus main body (not shown) and provided to mesh with the first gear 51a and the second gear 53a.

The urging member 57 is formed of a coil spring configured to urge the rotary shaft 121a provided to the photosensitive member 121 into the right direction. The urging member 57 exerts an urging force to bring the cam followers 51b into press-contact with the cam surfaces 53b.

When the first gear member 51 is driven to rotate by a drive source such as the motor (not shown), corresponding to rotation of the photosensitive member 121, the idle gear 55 meshing with the first gear 51a rotates. Further, the second gear 53a meshing with the idle gear 55, in other words, the second gear member 53 rotates. Although the first gear member 51 and the second gear member 53 rotate in the same rotational direction, the first gear member 51 and the second gear member 53 rotate at different rotational speeds owing to a difference in number of teeth between the first gear 51a and the second gear 53a. By rotation of the first gear member 51 and the second gear member 53 at the different rotational speeds, the abutting positions of the cam followers 51b and the cam surfaces 53b vary. In accordance the variation in abutting position, the photosensitive member 121 moves in the axial direction toward the left side while rotating against the urging force of the urging member 57. As a result, the photosensitive member 121 enters the state illustrated in FIG. 2B. When the first gear member 51 is further driven to rotate, the photosensitive member 121 moves in the axial direction toward the right side from the state of FIG. 2B, to thereby return into the state of FIG. 2A. In this way, the photosensitive member 121 rotates and reciprocates in the axial direction. Thus, even when the cleaning blade 25 is fixed, residual toner is scraped off by the cleaning blade 25 from the surface of the photosensitive member 121, and the residual toner thus scraped off is not stuck between the cleaning blade 25 and the surface of the photosensitive member 121. Thus, there is no risk that the surface of the photosensitive member 121 is repeatedly rubbed by the residual toner. As a result, the residual toner on the photosensitive member 121 is removed without damaging the surface of the photosensitive member 121. Note that, instead of driving the first gear member 51 to rotate, the rotary shafts 121a may be rotated, or the second gear member 53 may be driven to rotate.

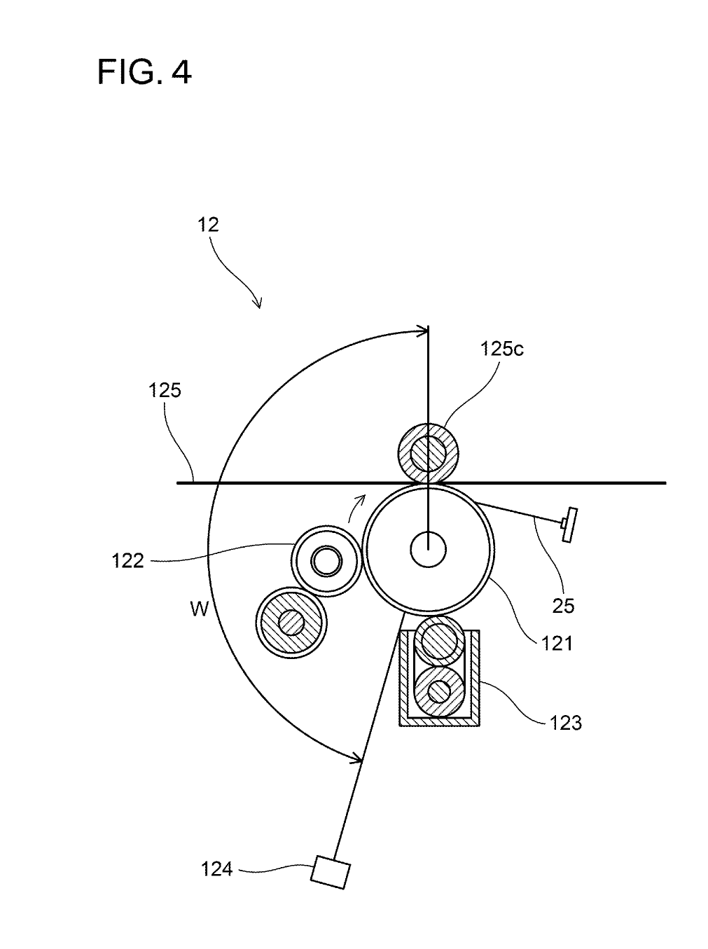

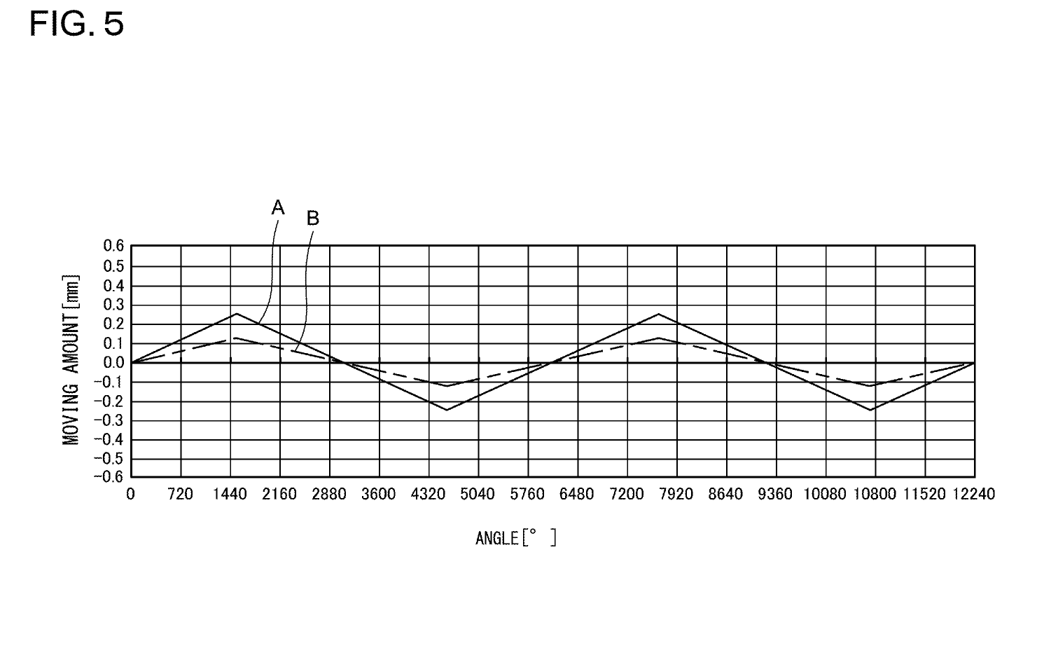

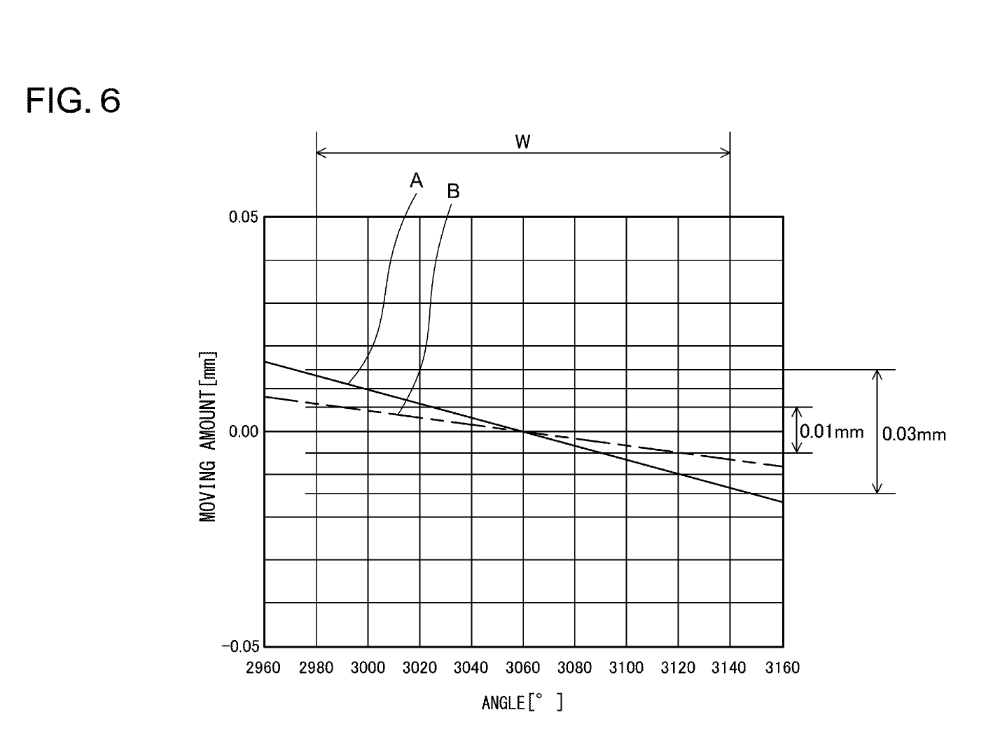

By the way, in the color-image forming apparatus, when each of the photosensitive members 121 for the respective colors is configured to move in the axial direction so as to be removed the residual toner at the time of image formation, there is a risk that an axial color shift occurs in each of the primary transfer sections. In this context, a structure for suppressing the color shift is described with reference to FIGS. 4 to 6. FIG. 4 is a sectional view of the image forming section 12. FIG. 5 is a graph illustrating axial moving amounts of the photosensitive member 121. FIG. 6 is a graph illustrating axial moving amounts of the photosensitive member 121 during a process of from exposure to transfer for image formation. Note that, in FIG. 4, the image forming section 12 illustrated in FIG. 1 is viewed from a rear surface side.

As illustrated in FIG. 4, in the image forming section 12, the charging portion 123, the exposure portion 124, the developing portion 122, the primary transfer roller 125c constituting the transfer section, and the cleaning blade 25 are disposed around the photosensitive member 121 and along the rotational direction of the same. The toner image on the photosensitive member 121 is primarily transferred by the primary transfer roller 125c onto the intermediate transfer belt 125 as a transfer medium.

The primary transfer roller 125c is spaced apart from the exposure portion 124 at an angle W in a circumferential direction. In this embodiment, the angle W is set to 164°, and an angle between the cleaning blade 25 and the charging portion 123 is set to 129°.

The number of teeth of the first gear 51a (refer to FIGS. 2A and 2B) is set to thirty five, and the number of teeth of the second gear 53a (refer to FIGS. 2A and 2B) is set to thirty four. Further, the cam surface 53b is formed to change (vary) constantly in axial distance by a predetermined amount with respect to the unit rotation angle, and a maximum variation amount in the axial direction of the cam surface 53b is set to 0.5 mm. As described above, the two cam surfaces 53b are formed separately at 180° in the circumferential direction on the left-side surface of the second gear member 53 (refer to FIG. 3).

When the first gear member 51 is driven to rotate in the drive mechanism 50 configured as described above, the photosensitive member 121 reciprocates as illustrated by the solid line A in FIG. 5. In FIG. 5, the abscissa axis represents the rotational angle of the first gear member 51 (unit: °), and the ordinate axis represents the moving amount of the photosensitive member 121 (unit: mm) The photosensitive member 121 reciprocates twice while rotating 12,240° (thirty-four times), in other words, moves in the axial direction within the range of 0.5 mm.

FIG. 6 illustrates a part of FIG. 5 on an enlarged scale, specifically, moving amounts of the photosensitive member 121 in a case where the photosensitive member 121 rotates at the angle W from the exposure portion 124 to the primary transfer roller 125c. As illustrated by the solid line A in FIG. 6, the photosensitive member 121 moves by 0.0261 mm in the axial direction while rotating through the angle W.

At the time of image formation, even when each of the photosensitive members 121 moves in the axial direction by 0.0261 mm, the color shift of the toner images due to the photosensitive members 121 is allowable. Further, when the photosensitive member 121 is moved in the axial direction within the range of 0.5 mm while being rotated, foreign matter such as residual toner and paper powder on the photosensitive member 121 can be removed by the cleaning blade 25 without damaging the surface of the photosensitive member 121.

Further, the dashed line B in FIG. 5 illustrates a case where: the number of teeth of the first gear 51a (refer to FIGS. 2A and 2B) is set to thirty five; the number of teeth of the second gear 53a (refer to FIGS. 2A and 2B) is set to thirty four; two cam surface 53b are formed so as to change (vary) constantly in axial distance by a predetermined amount with respect to the unit rotation angle; and the maximum variation amount in the axial direction of each of the cam surfaces 53b is set to 0.25 mm.

With this setting, the photosensitive member 121 reciprocates twice while rotating 12,240° (thirty-four times), in other words, moves in the axial direction within the range of 0.25 mm. Further, as illustrated in FIG. 6, the photosensitive member 121 moves in the axial direction by 0.0131 mm when rotating through the angle W.

At the time of image formation, even when each of the photosensitive members 121 moves in the axial direction by 0.0131 mm, the color shift of the toner images due to the photosensitive members 121 is allowable. Further, when the photosensitive member 121 is moved in the axial direction within the range of 0.25 mm while being rotated, foreign matter such as residual toner and paper powder on the photosensitive member 121 can be removed by the cleaning blade 25 without damaging the surface of the photosensitive member 121.

With the above-mentioned setting, even when the photosensitive member 121 is moved in the axial direction within a range of from 10 to 30 μm while the photosensitive member 121 rotates from the exposure portion 124 to the primary transfer roller 125c, the color shift of the toner images due to the photosensitive members 121 can be suppressed. In addition, residual toner on the photosensitive member 121 can be removed without damaging the surface of the photosensitive member 121.

Note that, as described above in this embodiment, although an example in which the present disclosure is applied to a color-image forming apparatus is described, the present disclosure is not limited thereto, and may be applied to a monochrome-image forming apparatus in which sheets are used as transfer media.

The present disclosure is usable for an image forming apparatus such as a electrophotographic copier, printer, facsimile, and multifunction peripheral having functions of those devices, and more particularly, for an image forming apparatus capable of removing residual toner on an image carrier.

1. An image forming apparatus, comprising:
an image carrier configured to carry a toner image;
a cleaning member configured to remove residual toner on the image carrier by contacting a surface of the image carrier; and
a drive mechanism configured to rotate the image carrier and for reciprocating the image carrier in an axial direction of the image carrier.

2. An image forming apparatus according to claim 1, wherein the drive mechanism comprises:
a first gear member provided to the image carrier;
a second gear member facing the first gear member, being rotatable coaxially with the first gear member, disposed immovably in the axial direction, and being different in number of teeth in comparison with the first gear member;
an idle gear provided to mesh with both the first gear member and the second gear member;
a cam surface provided to one of the first gear member and the second gear member and varying in axial distance in a circumferential direction of the one of the first gear member and the second gear member;
a cam follower provided to another of the first gear member and the second gear member so as to be abuttable with the cam surface; and
an urging member configured to urge the image carrier into a direction in which the cam surface and the cam follower abut each other.

3. An image forming apparatus according to claim 2, wherein the one of the first gear member and the second gear member comprises a profile-shifted gear.

4. An image forming apparatus according to claim 2, wherein the cam surface is formed to vary in the axial direction by a fixed amount per unit rotation angle.

5. An image forming apparatus according to claim 2,
wherein the cam surface comprises at least two cam surfaces provided at positions of equally dividing a circumference of the first gear member, and
wherein the cam follower comprises at least two cam followers provided at positions of equally dividing a circumference of the second gear member.

6. An image forming apparatus according to claim 2, wherein the first gear member is driven to rotate.

7. An image forming apparatus according to claim 1, wherein the cleaning member is fixed to a cleaning portion configured to house residual toner removed from the image carrier.

8. An image forming apparatus according to claim 1, further comprising, around the image carrier and along a rotational direction of the image carrier:
an exposure portion configured to form an electrostatic latent image by applying a light beam based on original image data onto the surface of the image carrier;
a developing portion configured to convert the electrostatic latent image on the image carrier into a toner image; and
a transfer section configured to transfer the toner image on the image carrier onto a transfer medium,
wherein the image carrier moves in the axial direction from 10 to 30 μm while rotating from the exposure portion to the transfer section.

9. An image forming apparatus according to claim 8,
wherein the transfer medium comprises an intermediate transfer member,
wherein the image carrier comprises a plurality of image carriers disposed on a moving path of the intermediate transfer member, and
wherein a color image is formed by forming toner images of respective colors respectively onto surfaces of the plurality of image carriers, and sequentially superimposing and transferring the toner images of the respective colors, which have been formed respectively on the surfaces of the plurality of image carriers, onto the intermediate transfer member.
